(19) United States
(12) Patent Application Publication
(10) Pub. No.: US 2025/0296517 A1
(43) Pub. Date: Sep. 25, 2025

(54) MOTOR VEHICLE WITH A WATER TANK AND AN INTAKE OPENING FORMED ON BOTH SIDES OF A LONGITUDINAL CENTER AXIS IN A COVER ELEMENT OF THE WATER TANK

(71) Applicant: AUDI AG, Ingolstadt (DE)

(72) Inventors: Sebastian ALBL, Weinböhla (DE); Christoph BEHLE, Pörnbach (DE); Amr KHOBEIZ, München (DE); Frantisek PAUR, Kosmonosy (CZ); Stefan WELZ, lngolstadt (DE)

(73) Assignee: AUDI AG, Ingolstadt (DE)

(21) Appl. No.: 19/073,274

(22) Filed: Mar. 7, 2025

(30) Foreign Application Priority Data
Mar. 25, 2024 (DE) 102024108414.6

(51) Int. Cl. B60R 13/07; B60H 1/00; B62D 25/08

(52) U.S. Cl. CPC B60R 13/07; B62D 25/081; B60H 2001/00085

(57) ABSTRACT

A motor vehicle with an internal combustion engine and/or electric drive is described, wherein the motor vehicle has a windshield; a water tank which is arranged in front of the windshield and is designed to collect and drain water which accumulates in a transition region of the windshield and a front hood. The water tank includes a base element and a cover element which form an intake space for fresh air; a fresh air inlet of an air conditioning unit which is in fluid communication with the intake space. An intake opening for fresh air is formed in the cover element. The intake opening is formed on both sides of a longitudinal center axis of the motor vehicle relative to a width direction of the motor vehicle.

### FIELD

The invention relates to a motor vehicle with an internal combustion engine and/or electric drive, wherein the motor vehicle has: a windshield; a water tank arranged in front of the windshield, which is designed to collect and drain water accumulating in a transition region between the windshield and a front hood; wherein the water tank has a base element and a cover element, which form an intake space for fresh air; a fresh air inlet of an air conditioning unit, which is in fluid communication with the intake space; wherein the cover element has a baffle extending along the windshield with a baffle channel facing the windshield for draining water to both sides of the motor vehicle; wherein an intake opening for fresh air is formed in the cover element; and wherein a water collection basin with a base surface is formed in the base element;

### BACKGROUND

Such a motor vehicle is known, for example, from EP 2 236 332 A2. Furthermore, reference is also made to DE 40 12 568 C1, which also discloses a motor vehicle with a water tank.

Until now, known motor vehicles have had a sufficiently large prestige dimension to be able to provide a fresh air path suitable in terms of airflow parameters. The fresh air path is defined in particular by means of the bulkhead components (water tank base, water tank front wall, water tank cover), front wall between the interior and engine compartment and spring strut mounts. The fresh air should flow in the width direction of the vehicle through the jagged water tank, which has a depth in the vertical direction, to the outside (to the side) to the fresh air inlet of the air conditioning device or climate control unit in order to enable maximum water separation. The air conditioning unit is arranged on the passenger side, depending on the steering, with the fresh air path also being designed from the driver to the passenger side, depending on the steering. In known water tanks it has been shown that a large amount of water is taken in through the intake opening in the water tank cover (cover element), which is only separated inside the water tank.

Due to the so-called cab-forward design for an increased interior volume and requirements regarding a flat front hood, an air path with sufficiently good flow parameters and water separation is no longer possible, especially in the previous longitudinal and vertical extension.

### SUMMARY

The object of the invention is to provide a motor vehicle with a water tank in which the above disadvantages can be avoided, wherein reliable water separation is to be provided in a small space, in particular with sufficiently low flow velocities and the largest possible flow cross-sections for the intake outside air.

A motor vehicle is thus proposed, with an internal combustion engine and/or electric drive, wherein the motor vehicle has: a windshield; a water tank arranged in front of the windshield, which is designed to collect and drain water accumulating in a transition region between the windshield and a front hood; wherein the water tank has a base element and a cover element, which form an intake space for fresh air; a fresh air inlet of an air conditioning unit, which is in fluid communication with the intake space; wherein the cover element has a baffle extending along the windshield with a baffle channel facing the windshield for draining water to both sides of the motor vehicle; wherein an intake opening for fresh air is formed in the cover element; and wherein a water collection basin with a base surface is formed in the base element. It is provided that the intake opening is formed on both sides of a longitudinal center axis of the motor vehicle with respect to a width direction of the motor vehicle.

By arranging the intake opening in a central or middle region, in particular on both sides of the longitudinal center axis of the motor vehicle, in conjunction with the baffle running along the windshield, the entry of larger quantities of water into the intake space for fresh air can be avoided or prevented.

In the motor vehicle, the intake opening can have an upwardly projecting, circumferential edge projection. Such an edge projection, which can also be called a circumferential web, forms a further element to prevent water from entering through the intake opening.

In the motor vehicle, the intake opening and the base surface of the water collection basin can have substantially the same shape, in particular with a trapezoidal configuration.

In particular, the intake opening and the water collection basin can be arranged one above the other, in particular such that the intake opening and the base surface are aligned or substantially oriented congruent with each other.

This ensures that water still entering through the intake opening or any water droplets carried into the intake space by air currents can be collected or separated directly below the intake opening.

In the motor vehicle, the base surface of the water collection basin can be inclined in the longitudinal direction and in the width direction of the motor vehicle. This ensures that water collecting in the water collection basin can be directed to a lowest point. In particular, the base surface for water separation can be continuously inclined in one direction.

A drain can be arranged at a lowest point, in particular in a corner region of the base surface, to drain away water collected in the water collection basin. Such a drain is arranged in particular at the lowest point of the water collection basin so that the water can be reliably drained out of the water tank.

For this purpose, a water pipe, for example in the form of a hose or a particularly deformable pipe, can be connected to the drain of the water collection basin so that the water can be drained away to the environment past other vehicle components, in particular electrical components.

In the motor vehicle, multiple struts can be arranged in front of the windshield, which are inclined to one another and define a polygonal receiving space between them.

Such struts can be attached in particular to body components of the motor vehicle, for example in the region of the side strut domes and/or in the region of a cross member or a partition wall that separates the vehicle interior from the engine compartment. The struts can therefore also be called body struts.

The base element can be supported by the struts and the base surface can be arranged in the receiving space formed by the struts.

This allows the receiving space created by the struts to be used optimally to accommodate therein the water collection basin of the water tank.

In the motor vehicle, the base surface of the base element can have a shape which is substantially the same, in particular identical, in a left-hand drive motor vehicle and in a right-hand drive motor vehicle. In other words, the base surface of the base element can be designed to be independent of the steering side.

This makes it possible, for example, for the intake opening and the water collection basin to be arranged or housed at the same location on the motor vehicle, in particular at the same position in relation to the above-mentioned struts, regardless of the steering side.

In the motor vehicle, the base element of the water tank can be designed such that it is arranged above a braking system of the motor vehicle arranged in front of the windshield.

### BRIEF DESCRIPTION OF THE FIGURES

Further advantages and details of the invention result from the following description of embodiments with reference to the figures. In particular:

FIG. 1 shows a simplified and schematic plan view of a front part of a motor vehicle with windshield and front hood;

FIG. 2 shows a plan view similar to FIG. 1 without front hood with a view of a water tank;

FIG. 3 shows a simplified and schematic sectional view approximately according to the section line III-III of FIGS. 1 and 2;

FIG. 4 shows a simplified and schematic sectional view approximately according to the section line IV-IV of FIG. 2;

FIG. 5 shows a simplified and schematic perspective view of the front part of the motor vehicle;

FIG. 6 shows a simplified and schematic perspective view of the front part of the motor vehicle;

FIG. 7 shows a simplified and schematic plan view of a base element of the water tank on a left-hand drive motor vehicle;

FIG. 8 shows a simplified and schematic plan view of a base element of the water tank on a right-hand drive motor vehicle.

### DETAILED DESCRIPTION

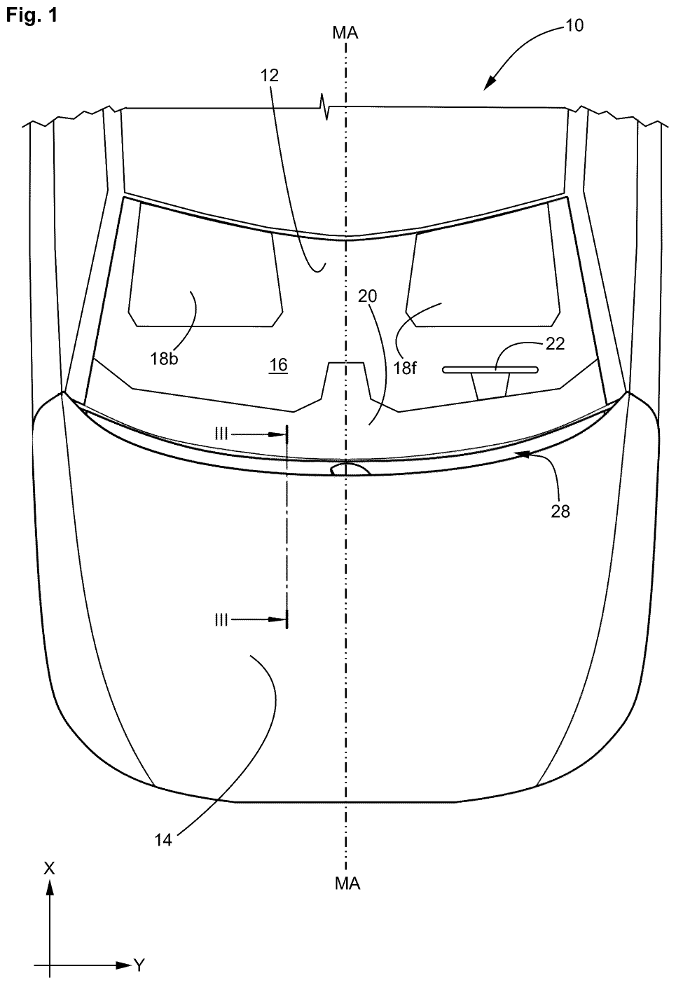

FIG. 1 shows a simplified and schematic plan view of a front part of a motor vehicle 10. In this view, a windshield 12 (also referred to as windscreen) and a front hood 14 of the motor vehicle 10 can be seen.

Behind the windshield 12 there is an interior 16 of the motor vehicle 10. In this, a driver's seat 18f and a passenger seat 18b are schematically shown, as well as a console 20 and a steering wheel 22.

In FIG. 1 and also in the following figures, a longitudinal direction of the motor vehicle is designated by X, a width direction by Y and a vertical direction (orthogonal to X and Y) by Z. In FIG. 1, an imaginary longitudinal center axis MA of the motor vehicle 10 is also shown as a dash-dotted line.

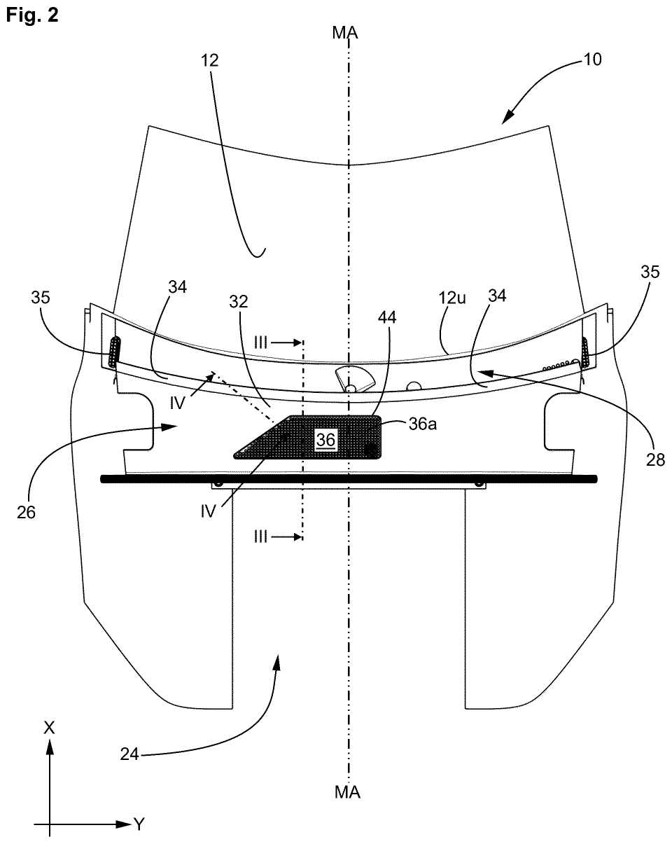

The front hood 14 covers an installation space 24 (FIG. 2) which usually contains technical components, in particular for a drive motor, electronic and/or hydraulic systems, such as a braking system, a refrigeration system or the like.

FIG. 2 shows a plan view similar to that of FIG. 1, wherein the front hood 14 and other parts of the motor vehicle 10 shown in FIG. 1 are not shown again. The view of the installation space 24 is clear due to the front hood 14 not being shown, wherein no technical components arranged therein are shown.

In FIG. 2, a water tank 26 arranged in front of the windshield 12 can be seen, which is designed to collect and drain water accumulating in a transition region 28 (FIG. 1) between the windshield 12 and the front hood 14.

The water tank 26 has a base element 30 (not visible in FIG. 2) and a cover element 32. The cover element 32 has a baffle 34 running along the windshield 12, in particular along its lower edge 12u. An intake opening 36 for fresh air is formed in the cover element 32.

The intake opening 36 usually has a grid or sieve-like cover 36a to prevent the entry of larger particles or leaves.

The baffle 34 is continuous from a left side to a right side of the motor vehicle 10. In particular, the baffle 34 has a curved length in the width direction Y which substantially corresponds to a curved length of the lower edge 12u of the windshield 12 or is slightly shorter, in particular at least 80% of the curved length of the lower edge 12u. In order to be able to drain water that is diverted by the baffle 34 to the side, lateral drain openings 35 are provided.

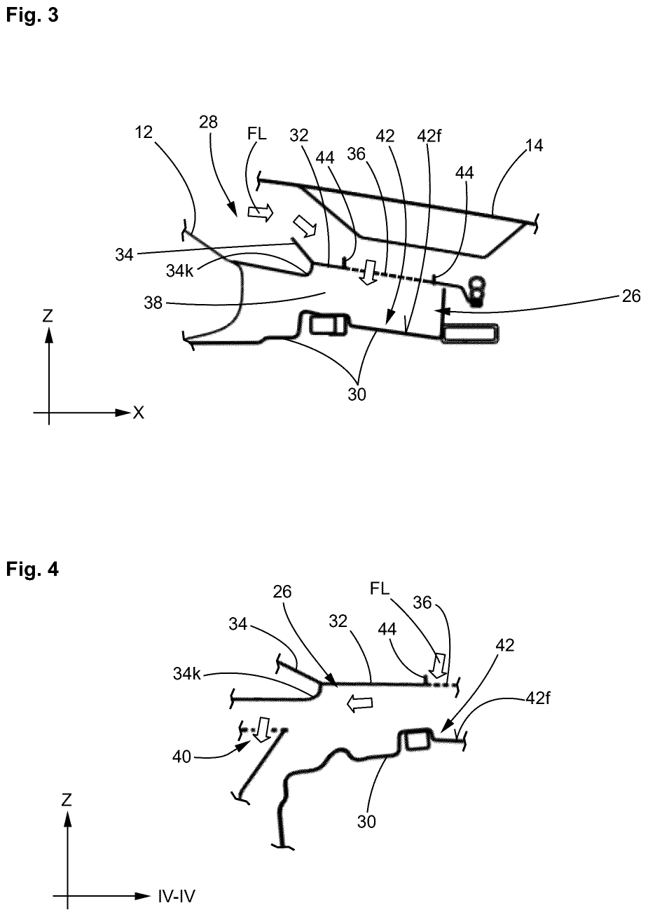

FIG. 3 shows a simplified cross-section according to the section line III-III of FIGS. 1 and 2.

This illustration shows the front hood 14, which is arranged above the water tank 26. The water tank 26 has the cover element 32 already shown in FIG. 2. In this illustration, the already mentioned base element 30 is also visible.

An intake space 38 for fresh air is formed between the cover element 32 and the base element 30. Fresh air enters the water tank 26 through the intake opening 36 and is guided within the intake space 38 to a fresh air inlet 40 (FIG. 4 and FIG. 6) of an air conditioning unit not shown in detail. A water collection basin 42 with a base surface 42f is formed in the base element 30.

From FIG. 3 it can also be seen that the baffle 34 running along the windshield 12 has a baffle channel 34k facing the windshield for draining water to both sides of the motor vehicle. The baffle channel 34k can, for example, be concave in relation to the windshield 12.

Referring to FIG. 2, it can be seen that the intake opening 36 is formed on both sides of the longitudinal center axis MA of the motor vehicle 10 with respect to the width direction Y of the motor vehicle 10. In other words, the intake opening 36 of the water tank 26 or of the cover element 32 is arranged centrally with respect to the width direction Y. In other words, an imaginary X-Z plane containing the longitudinal center axis MA intersects an imaginary plane containing the intake opening 36.

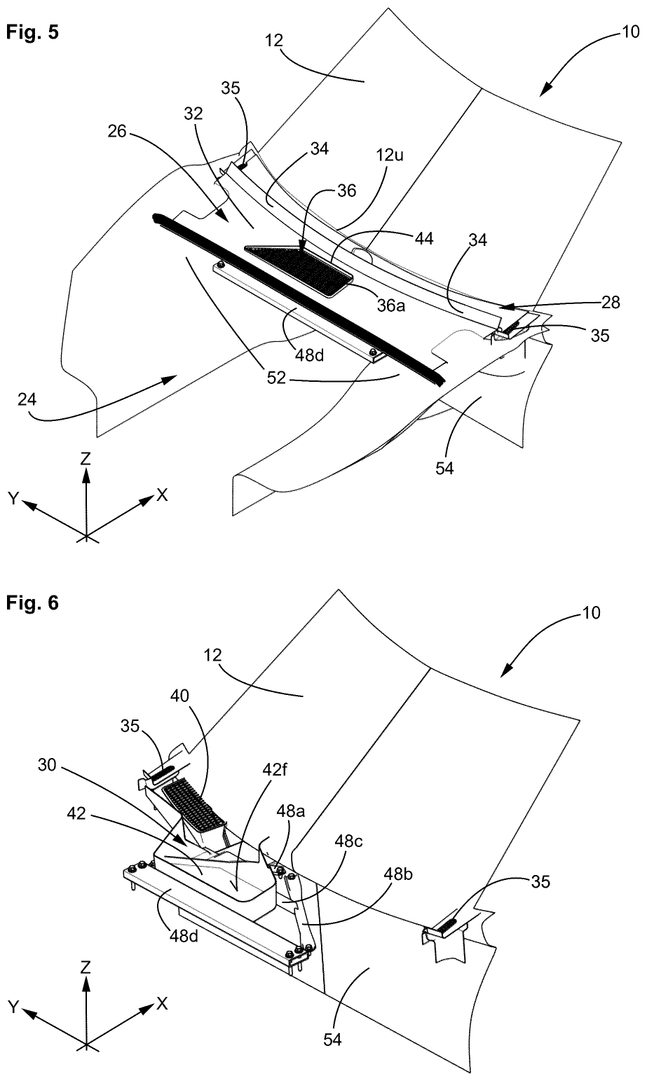

From FIG. 3 and FIG. 5 it can be seen that the intake opening 36 has a circumferential edge projection 44 projecting upwards, in particular in the Z direction. The edge projection 44 can also be referred to as a circumferential web.

FIG. 4 shows a simplified sectional view approximately along section line IV-IV of FIG. 2. This sectional view also shows the intake space 38, which is delimited by the cover element 32 and the base element 30. Fresh air FL enters through the intake opening 36 and is directed laterally to the above-mentioned fresh air inlet 40 of an air conditioning unit (not shown).

From the combination of FIGS. 3 and 4, it is also apparent that the base surface 42f of the water collection basin 42 is inclined in the longitudinal direction X and in the width direction Y of the motor vehicle 10.

Other elements shown in FIG. 4 are identified by the same reference numerals as in the previous figures, so that a further description of these elements can be omitted here.

FIGS. 5 and 6 show the motor vehicle 10 with windshield 12 in a simplified perspective view.

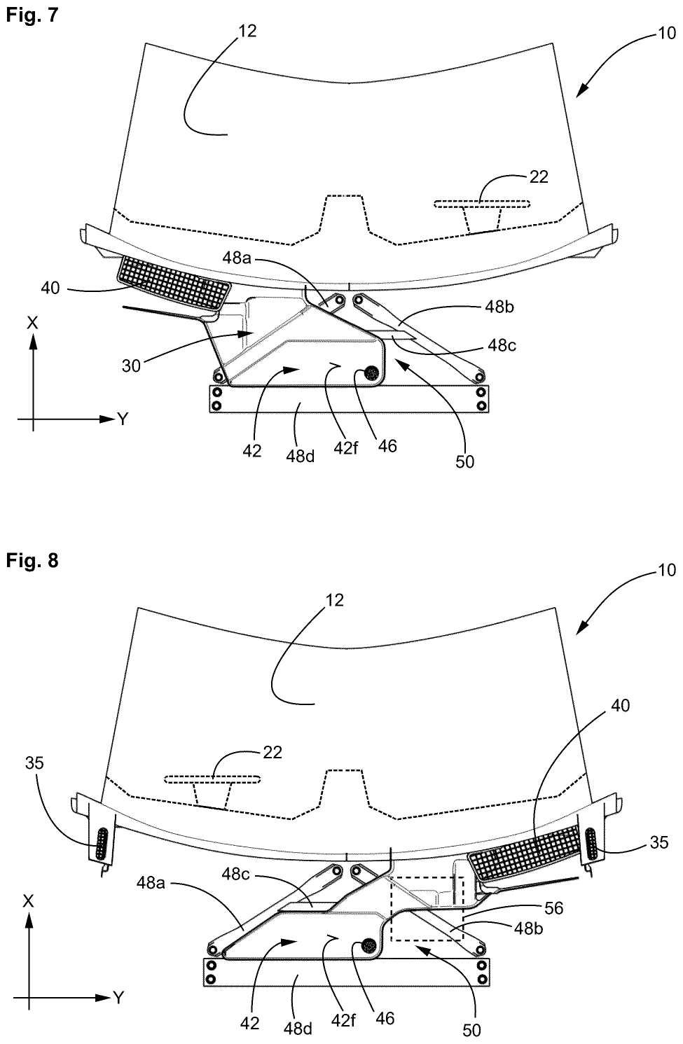

In FIG. 5, the cover element 32 of the water tank 26 can be seen. In FIG. 6, the cover element 32 is not shown so that the base element 30 can clearly be seen. A plan view without cover element 32 is shown in FIG. 7. The following description refers to a combined view of FIGS. 5 to 7.

It can be seen that the intake opening 36 and the base surface 42f of the water collection basin 42 have substantially the same shape. In particular, they have a trapezoidal design. This is also evident from the combination of FIG. 2 and FIG. 7.

Furthermore, it can be seen that the intake opening 36 and the water collection basin 42 are arranged one above the other, in particular such that the intake opening 36 and the base surface 42f are aligned or substantially oriented congruent with each other.

In particular, it can be seen from FIG. 7 that a drain 46 is arranged in a corner region of the base surface 42f, the drain being for draining water collected in the water collection basin 42. The drain 46 can in particular be arranged at a lowest point or region of the inclined base surface 42f. The drain 46 can, for example, be designed as a non-return nozzle.

Multiple struts 48a, 48b, 48c, 48d are arranged in front of the windshield 12. The struts 48a, 48b, 48c, 48d are oriented at an angle to one another, so that a polygonal receiving space 50 is formed or defined between them. The receiving space 50 can in particular be triangular or square, wherein, for example, a trapezoidal receiving space 50 is defined by all four struts 48a, 48b, 48c, 48d.

The base element 30 of the water tank 26 is supported by the struts 48a, 48b, 48c, 48d, wherein the base surface 42f of the water collection basin 42 is arranged in the receiving space 50 formed by the struts 48a, 48b, 48c, 48d.

The struts may also be referred to as follows: dome strut 48d, right A-strut 48a, left A-strut 48b and connecting strut 48c.

The shape of the water collection basin 42 or the base surface 42f particularly takes up the geometry provided by the right A-strut 48a, the dome strut 48d and the connecting strut 48c. The receiving space 50 formed between the struts 48a, 48c, 48d is only partially occupied by the water collection basin 42.

The struts 48a, 48b, 48c, 48d are supported in particular on other body parts of the motor vehicle 10 or are connected to them, such as lateral spring strut domes 52 (illustrated in a highly simplified manner in FIG. 5) and/or in the region of a cross member or a partition wall 54 (FIG. 5) which separates the vehicle interior from the engine compartment.

While FIGS. 1 to 7 show a motor vehicle with left-hand steering (steering wheel 22), FIG. 8 shows an embodiment of the base element 30 for a right-hand steered (steering wheel 22) motor vehicle.

From the combined view of FIGS. 7 and 8, it is apparent that the base surface 42f of the base element 30 has a shape which is substantially the same, in particular identical, in a left-hand drive motor vehicle 10 (FIGS. 1 to 7) and in a right-hand drive motor vehicle 10 (FIG. 8). In particular, the base surface 42f or the water collection basin 42 of the base element 30 of the water tank 26 can be positioned equally relative to the struts 48a, 48b, 48c, 48d.

With reference to FIG. 8, it is also pointed out that the base element 30 of the water tank 26 can be designed such that it is arranged above a braking system 56 (shown in simplified form as a dashed rectangle) of the motor vehicle 10 arranged in front of the windshield 12. FIG. 8 is to be understood purely as an example, because the base element 30 is also designed in an embodiment according to FIG. 7 such that it is arranged above further components accommodated in the installation space 24 in front of the windshield 12.

With reference to FIGS. 7 and 8, it is pointed out that a free region of the receiving space 50 formed between the struts 48a, 48c, 48d, which is not occupied by the water collection basin 42, can be used as an access opening for an underlying component of the motor vehicle 10, for example an opening for a fluid container, such as a brake fluid container of the brake system 56.

By means of the water tank 26 described above, a multi-stage water drain concept can be provided. In a first stage, water is drained away by means of the baffle 34. In a second stage, water which enters the intake opening 38 through the intake opening 36 is retained in the water collection basin 42 and drained away.

As a third stage, the fresh air inlet 40 is arranged higher in the vertical direction Z relative to the water collection basin 42. In particular, a grille covering the fresh air inlet 40 is higher than the base surface 42f. A sort of trench is formed between the fresh air inlet 40 and the water collection basin 42, which trench serves to drain water that has been sucked behind the water collection basin 42, in particular due to the air flow. The water that has reached this point can flow away outside the fresh air inlet or below it, for example through a non-return nozzle.

From the combination of FIGS. 1 to 8, it is also apparent that the water tank 26 described here serves to provide a flat structure for the intake of fresh air with respect to the extension in the vertical direction Z. Furthermore, the water tank 26 is arranged so that a pedestrian protection deformation region is used for the fresh air flow

It is generally pointed out that more reference numerals may be shown in the respective FIGS. 1 to 8 than are contained in the descriptive text with respect to this figure. A description of a reference numeral in a figure can also be adopted or apply to another figure if the reference numeral in question is only shown in the other figure but is not described separately.

1. A motor vehicle with an internal combustion engine and/or electric drive, wherein the motor vehicle comprises:
a windshield;
a water tank arranged in front of the windshield, which is designed to collect and drain water accumulating in a transition region between the windshield and a front hood;
wherein the water tank has a base element and a cover element which form an intake space for fresh air;
a fresh air inlet of an air conditioning unit which is in fluid communication with the intake space;
wherein the cover element has a baffle running along the windshield with a baffle channel facing the windshield for draining water to both sides of the motor vehicle;
wherein an intake opening for fresh air is formed in the cover element; and
wherein a water collection basin with a base surface is formed in the base element;
wherein the intake opening is formed on both sides of a longitudinal center axis of the motor vehicle relative to a width direction of the motor vehicle.

2. The motor vehicle according to claim 1, wherein the intake opening has an upwardly projecting, circumferential edge projection.

3. The motor vehicle according to claim 1, wherein the intake opening and the base surface of the water collection basin have substantially the same shape, in particular a trapezoidal configuration.

4. The motor vehicle according to claim 1, wherein the intake opening and the water collection basin are arranged one above the other, in particular such that the intake opening and the base surface are aligned or oriented substantially congruent with each other.

5. The motor vehicle according to claim 1, wherein the base surface is inclined in the longitudinal direction and in the width direction of the motor vehicle.

6. The motor vehicle according to claim 4, wherein a drain is arranged at a lowest point, in particular in a corner region of the base surface for draining off water collected in the water collection basin.

7. The motor vehicle according to claim 1, wherein multiple struts are arranged in front of the windshield, which struts are aligned at an angle to one another and define a polygonal receiving space therebetween.

8. The motor vehicle according to claim 7, wherein the base element is supported by the struts and that the base surface is arranged in the receiving space formed by the struts.

9. The motor vehicle according to claim 1, wherein the base surface of the base element has a shape which is substantially the same, in particular identical, in a left-hand drive motor vehicle and in a right-hand drive motor vehicle.

10. The motor vehicle according to claim 2, wherein the intake opening and the base surface of the water collection basin have substantially the same shape, in particular a trapezoidal configuration.

11. The motor vehicle according to claim 2, wherein the intake opening and the water collection basin are arranged one above the other, in particular such that the intake opening and the base surface are aligned or oriented substantially congruent with each other.

12. The motor vehicle according to claim 3, wherein the intake opening and the water collection basin are arranged one above the other, in particular such that the intake opening and the base surface are aligned or oriented substantially congruent with each other.

13. The motor vehicle according to claim 2, wherein the base surface is inclined in the longitudinal direction and in the width direction of the motor vehicle.

14. The motor vehicle according to claim 3, wherein the base surface is inclined in the longitudinal direction and in the width direction of the motor vehicle.

15. The motor vehicle according to claim 4, wherein the base surface is inclined in the longitudinal direction and in the width direction of the motor vehicle.

16. The motor vehicle according to claim 2, wherein multiple struts are arranged in front of the windshield, which struts are aligned at an angle to one another and define a polygonal receiving space therebetween.

17. The motor vehicle according to claim 3, wherein multiple struts are arranged in front of the windshield, which struts are aligned at an angle to one another and define a polygonal receiving space therebetween.

18. The motor vehicle according to claim 4, wherein multiple struts are arranged in front of the windshield, which struts are aligned at an angle to one another and define a polygonal receiving space therebetween.

19. The motor vehicle according to claim 5, wherein multiple struts are arranged in front of the windshield, which struts are aligned at an angle to one another and define a polygonal receiving space therebetween.

20. The motor vehicle according to claim 6, wherein multiple struts are arranged in front of the windshield, which struts are aligned at an angle to one another and define a polygonal receiving space therebetween.
